(19) United States
(12) Patent Application Publication
(10) Pub. No.: US 2012/0261155 A1
(43) Pub. Date: Oct. 18, 2012

(54) CONNECTORS

(76) Inventor: Fu-Min Liang, New Taipei City (TW)

(21) Appl. No.: 13/089,275

(22) Filed: Apr. 18, 2011

(51) Int. Cl. H01R 4/00

(52) U.S. Cl. 174/86

(57) ABSTRACT

The present invention relates to a connector comprising a cylindrical base and a top structure. The cylindrical base comprises of at least one circular groove in axial and plural radical gaps on the surface of the open end. A spring and a metal ring plate are pre-compressed in the circular groove in order. The metal ring plate is positioned by placing its edge bulges into the gaps on the surface of the open end of the cylindrical base and can not rotate. By the wire through the gaps, the metal ring plate can be connected to the power or signal source outside. The top structure, which is installed at the open end of the cylindrical base, can rotate relative to the cylindrical base. There is at least one conductive pillar extended from the inner side of the top structure toward the cylindrical base. The conductive pillar, located in the circular groove, pressing the metal ring plate at the bottom side, forms an electric conduction link. Besides, each conductive pillar transmits electric current or signals from one side of the conductor to the other side through a wire installed through the conductor.

### BACKGROUND OF THE INVENTION

1. Field of the Invention

The present invention relates generally to the technology of a connector, and more particularly, to a connector which is rotatable in 360 degrees and pass current or signals, or pass current and signals at the same time.

2. The Prior Arts

In the aspect of electrical field, a connector is a common structure, in particular in use of connecting or transmitting current or signals among different units. In general, the terminal and male-female structure is used to achieve the connecting and positioning effect. Because the terminal and male-female structure does not belong to the technology of the present invention, it will not be mentioned in the following description.

In the electrical field, for example, in the lamp sets or surgical lights supported by connected rods with key position structure, there must be a connector in the key position in use of electrical conductivity. In a typical connector structure, the wire is installed directly in the connector. Accordingly, the rotation angle is limited by wire tension or by the over-winding wire, causing inconvenience in use.

Therefore, the inventor studied the disadvantages in structure of the typical connector and the inconvenience in use by limited rotation angle. After continuous effort and experiment, the inventor designed the present invention.

### SUMMARY OF THE INVENTION

The main purpose of the present invention is to solve the above problems and provide a connector, which is rotatable in 360 degrees and pass electrical energy or signals, or pass electrical energy and signals at the same time.

In order to achieve the purpose, the present invention mainly comprises of an open-ended cylindrical base and a top structure. The cylindrical base comprises of at least one circular groove in axial and plural radical gaps on the surface of the open end. A spring and a metal ring plate are pre-compressed in the circular groove in order. The metal ring plate is positioned by placing its edge bulges into the gaps on the surface of the open end of the cylindrical base and can not rotate. By the wire through the gaps, the metal ring plate can be connected to the power or signal source outside. The top structure, which is installed at the open end of the cylindrical base, can rotate relative to the cylindrical base. There is at least one conductive pillar extended from the inner side of the top structure toward the cylindrical base. The conductive pillar, located in the circular groove, pressing the metal ring plate at the bottom side, forms an electric conduction link. Besides, each conductive pillar transmits electric current or signals from one side of the conductor to the other side through a wire installed through the conductor.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a is a local exploded three-dimensional view of the connector illustrating a cylindrical base and a top structure;

FIG. 2 is a three-dimensional view of the connector illustrating a cylindrical base, a top structure, the metal ring plate and the spring.

FIG. 3 is a cutaway view of the connector.

FIG. 4 is a schematic diagram illustrating an operation of the connector.

### BRIEF DESCRIPTION OF MAIN COMPONENT SYMBOLS

| | | | |
|---|---|---|---|
| 10 | Cylindrical base | 11 | Circular groove |
| 12 | Guide groove | 13 | Gap |
| 14 | Spring | 15 | Metal ring plate |
| 151 | Edge bulge | 20 | Top structure |
| 21 | Conductive pillar | 22 | Pillar |
| 30 | Wire | 40 | Wire |

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

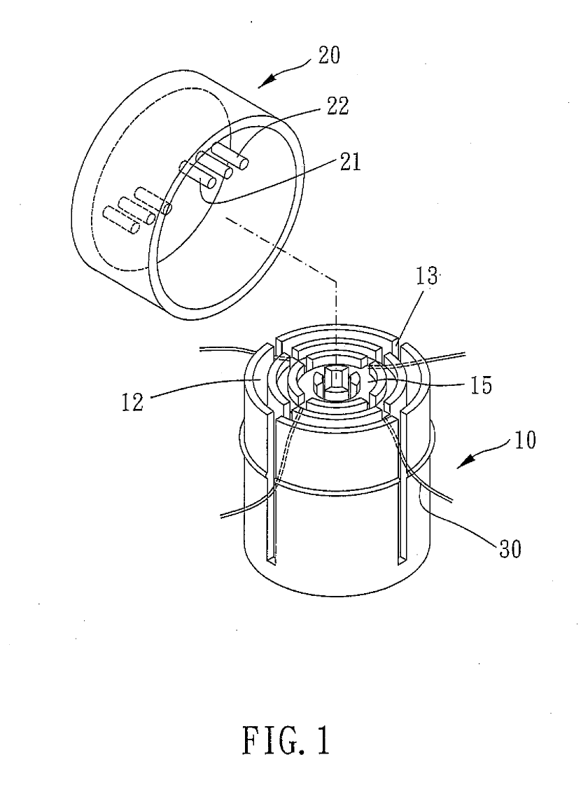

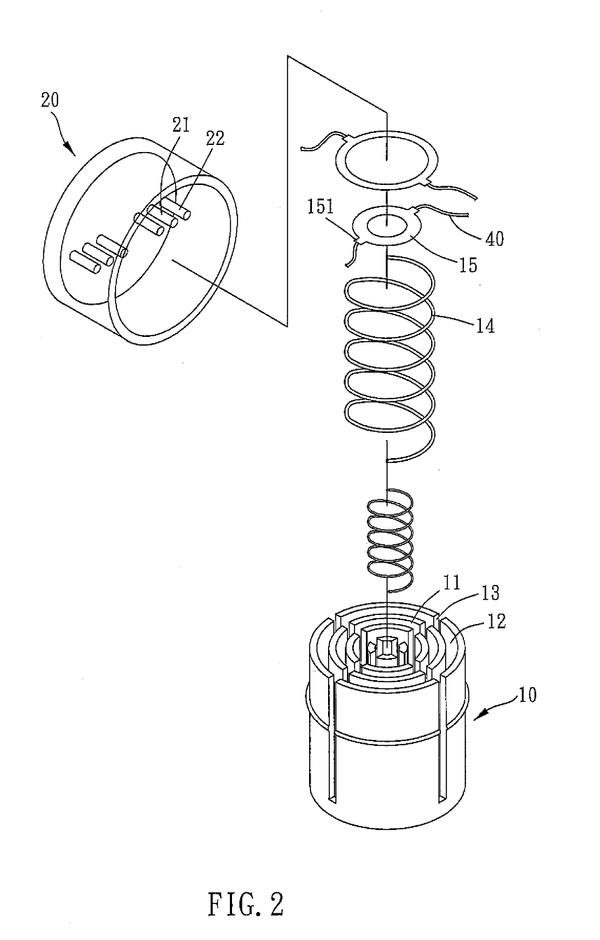

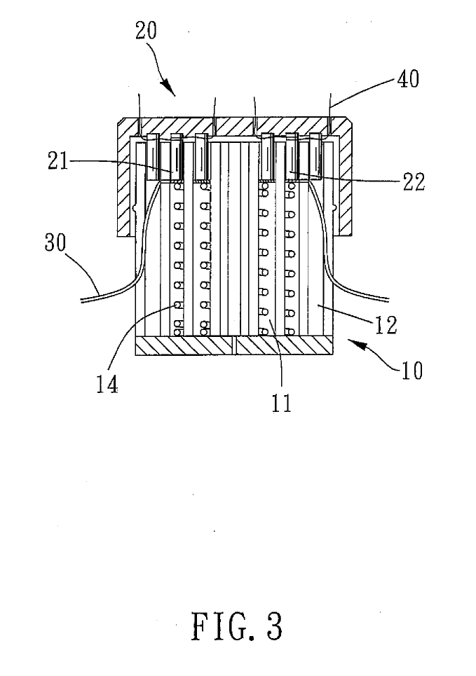

The present invention relates to a connector which is rotatable in 360 degrees and pass electrical energy or signals, or pass electrical energy and signals at the same time. As illustrated in FIG. 1 to FIG. 3, the connector mainly comprises of an open-ended cylindrical base (10) and a top structure (20) installed at the open end of the cylindrical base (10).

The cylindrical base (10) comprises of at least one circular groove (11) in axial and a guide groove (12); the circular groove (11) and the guide sheet (12) is concentric to each other. In the preferred embodiment, the cylindrical base (10) comprises of two circular grooves concentric to each other to correspond the positive and negative poles of current. The cylindrical base (10) comprises of plural radical gaps (13) on the surface of the open end and the depth of each gap (13) is greater than the height of the top structure (20). A spring (14) and a metal ring plate (15) are pre-compressed in the circular groove (11) in order. The metal ring plate (15) is positioned by placing its edge bulges (151) into the gaps (13) on the surface of the open end of the cylindrical base (10) and can not rotate relative to the cylindrical base (10). In addition, considering the cost and conductivity, the metal ring plate (15) is made of copper, and is connected to the power or signal source outside the connector by the wire (30) through the gap (13). The metal ring plate (15) comprises of plural edge bulges (151), each of which is positioned in a corresponding gap (13) to limit the rotation of the metal ring plate (15). Besides, the above-mentioned wire (30) through the gap is connected to the edge bulge (151).

There is at least one conductive pillar (21) and one pillar (22) extended from the inner side of the top structure (20) toward the cylindrical base (10). The conductive pillar (21), located in the circular groove (11), pressing the metal ring plate (15) at the bottom side, forms an electric conduction link, while the pillar (22) is placed in the guide groove (12) to stabilize the rotation of the top structure (20) relative to the cylindrical base (10). In addition, to avoid uneven pressure on the metal ring plate (15), each circular groove (11) is corresponding with two conductive pillars (21) at the same diameter. To corresponding with the above embodiment, the top structure (20) comprises of two sets of conductive pillars (21) and two pillars (22) and each conductive pillar (21) transmits electric current or signals from one side of the conductor to the other side through the wire (40) installed through the conductor.

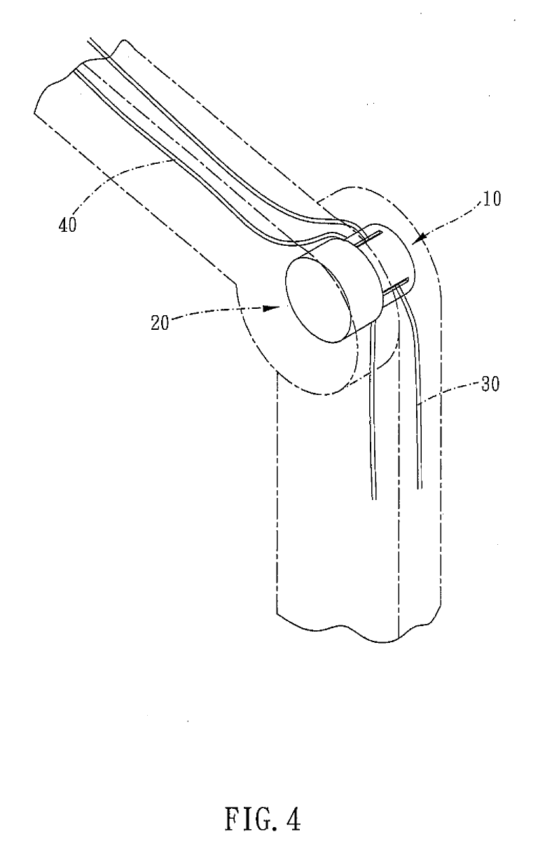

As illustrated in FIG. 4, when present invention is installed in the joint or key point of a set of connected rods, because the metal ring plate (15) does not rotate relative to the cylindrical base (10), the adjustment of the angle of the connected-rods apparatus, for example, a lamp, does not cause wire over-winding. Therefore, the angle is free in 360 degrees to overcome a typical connector's advantage.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A connector, comprising:
an open-ended cylindrical base and a top structure, comprising of at least one circular groove in axial and plural radical gaps on the surface of the open end;
a spring and a metal ring plate pre-compressed within the connector in order, wherein the metal ring plate is positioned by placing its edge bulges into the gaps on the surface of the open end of the cylindrical base and can not rotate, and the metal ring plate can be connected to the power or signal source outside by the wire through the gaps; and
a top structure, which is installed at the open end of the cylindrical base, can rotate relative to the cylindrical base, wherein at least one conductive pillar, extended from the inner side of the top structure toward the cylindrical base, is positioned in the circular groove, pressing the metal ring plate at the bottom side, forming an electric conduction link, and each conductive pillar transmits electric current or signals from one side of the conductor to the other side through a wire installed through the conductor.

2. The connector as claimed in claim 1, further comprising a guide groove in axis, which concentrically corresponds with the conductive groove, wherein at least a pillar, extended from the inner side of the top structure toward the cylindrical base, is positioned in the guide groove to stabilize the rotation of top structure relative to the cylindrical base.

3. The connector as claimed in claim 1, wherein the metal ring plate comprises of plural edge bulges, each of which is positioned in a corresponding gap to limit the rotation of the metal ring plate.

4. The connector as claimed in claim 2, wherein the metal ring plate comprises of plural edge bulges, each of which is positioned in a corresponding gap to limit the rotation of the metal ring plate.

5. The connector as claimed in claim 1, wherein the cylindrical base comprises of two circular groove centrically corresponding to each other to correspond to positive and negative poles of current and the top structure comprises of two sets of conductive pillars, each of which is positioned in a corresponding circular groove.

6. The connector as claimed in claim 2, wherein the cylindrical base comprises of two circular groove centrically corresponding to each other to correspond to positive and negative poles of current and the top structure comprises of two sets of conductive pillars, each of which is positioned in a corresponding circular groove.

7. The connector as claimed in claim 3, wherein the cylindrical base comprises of two circular groove centrically corresponding to each other to correspond to positive and negative poles of current and the top structure comprises of two sets of conductive pillars, each of which is positioned in a corresponding circular groove.
